(19) United States
(12) Patent Application Publication
(10) Pub. No.: US 2006/0081533 A1
(43) Pub. Date: Apr. 20, 2006

(54) Batch-continuous process and reactor

(76) Inventor: Boris M. Khudenko, Atlanta, GA (US)

Correspondence Address: Boris M. Khudenko, 744 Moores Mill Rd., Atlanta, GA, 30327, US

(21) Appl. No.: 10/966,972

(22) Filed: Oct. 16, 2004

(51) Int. Cl. C02F 3/00

(52) U.S. Cl. 210/607; 210/623; 210/195.1

(57) ABSTRACT

This is a method of batch-continuous operation for treatment and separation of liquid-solid mixtures in a reactor with reactive solids comprising steps of continuously feeding the liquid in the reactor, contacting (possibly, mixing) liquid with the solids in at least a portion of the reactor, periodically separating the liquid from the solids in unmixed, or predominantly unmixed, portion of the reactor, discharging at least a portion of the separated liquid from the reactor, and retaining the separated solids in the unmixed portion of the reactor, and periodically resuspending the solids in the unmixed portion of the reactor and transferring the resuspended soilds into the portion of the reactor for contacting liquid with the solids. The contacting and/or mixing of the liquid with the solids in the mixed portion of the reactor can be continuous or periodic mixing. The unmixed zone differs from the quiescent zone in conventional clarifiers. It is a flow-through zone with a noticeably high velocity of flow as in aeration tanks of biological treatment systems. The retention time in unmixed zones is much shorter than in clarifiers. The method and apparatus can be used to treat water and wastewater, and in various chemical, biochemical, and pharmaceutical processing operations.

### FIELD OF INVENTION

This is a method and apparatus for batch-continuous operation of chemical, physical-chemical, and biological processes involving liquids and suspended particulate materials, the method can be applied in water and wastewater treatment, chemical manufacturing, pharmaceutical industries, petrochemical processing, and other like industries.

### PRIOR ART

Continuous and batch processes involving liquids and suspended particles that need to be separated from liquids are well known. For example, the original biological wastewater treatment processes were batch operations including steps of filling wastewater into a tank containing active biomass (activated sludge), treating the wastewater by mixing the fed batch of wastewater with the biomass in the tank, settling the biomass under quiescent conditions and forming a clear layer of the treated wastewater on the top of the tank, decanting at least a portion of the clear layer, and repeating the sequence of these steps. Periodically, a step of evacuating the excess growth of biomass is also performed. Later, continuous operations of wastewater treatment had been developed, wherein the step of continuous feeding of wastewater influent in a biological treatment tank is provided, the fed wastewater is mixed and treated with biomass in this tank forming mixed liquor, the mixed liquor is continuously displaced by the continuously incoming influent into a separation means, usually a clarifier, wherein the treated and clarified wastewater effluent is separated from the biomass and evacuated from the biological treatment, whereas at least a portion of the separated biomass (biological sludge) is returned back into the biological treatment tank, the balance of the sludge is wasted from the system. Many modifications of these systems have been developed. Treatment steps may involve processes from strongly aerobic treatment to strongly anaerobic treatment and anything in between, with various combinations of oxidation-reduction conditions. Various biological process steps can be arranged in sequence, parallel flows, and counterflow. Biological processes can be combined with abiotic processes. various filters, including membranes, can be used for the continuous solid-liquid separation.

The main advantage of the batch process is simplicity of the apparatus. Ultimately, only one reaction tank is needed and clarification is performed in the same reaction tank. In reality, at least two parallel reactors, or a reactor and a storage tank are needed. A complex operation is the main disadvantage of the batch processes: the end of each process step needs to be determined and the change from one step to another needs to be executed. In other words, the efficiency of treatment needs to be determined to proceed from step to step. Probes for measuring efficiency are either non-existent or very expensive. Accordingly, less reliable time dependent controls are used. Present day automation systems alleviate the operation problems but do not eliminate them.

The main advantage of the continuous process is simplicity of operations. Ultimately, no time dependent controls are needed and operations may be steady-state. In reality, at least slow changes occur in the process and some process corrections are required. Automated controls are usually aimed at saving energy and at improving performance. A more complex reactor-and-clarifier design is the main disadvantage of the continuous processes as compared to batch processes. Present day membrane systems apparently simplify the biological treatment system, however, these filtration systems are very expensive and difficult to operate.

The main objective of the present invention is to provide a method and apparatus that combine the advantages of batch and continuous processing and eliminate the disadvantages of these operations. Other objectives will become apparent from the ensuing specification.

### BRIEF DESCRIPTION OF THE INVENTION

This is a method of batch-continuous operation for treatment and separation of liquid-solid mixtures in a reactor with reactive solids comprising steps of continuously feeding the liquid in the reactor, contacting (possibly, mixing) liquid with the solids in at least a portion of the reactor, periodically separating the liquid from the solids in unmixed, or predominantly unmixed, portion of the reactor, discharging at least a portion of the separated liquid from the reactor, and retaining the separated solids in the unmixed portion of the reactor, and periodically resuspending the solids in the unmixed portion of the reactor and transferring the resuspended soilds into the portion of the reactor for contacting liquid with the solids. The contacting and/or mixing of the liquid with the solids in the mixed portion of the reactor can be continuous or periodic mixing. The unmixed zone is not a quiescent zone as in conventional clarifiers. It is a flow-through zone with a noticeably high velocity of flow as in aeration tanks of biological treatment systems. The retention time in unmixed zones is much shorter than in clarifiers.

The liquid to be treated can be water, process water, wastewater, water solutions, biological growth media, water with dissolved organics, water with particulate organics, organic liquid, petroleum, petroleum products, and combinations thereof. The active solids can be represented by biomass, activated sludge, flocculent sludge, granular sludge, attached biological growth to the fixed media, attached biological growth to moving media, organic particles, inorganic particles, mineral particles, activated carbon, ion exchange resins, metal particles, iron particles, aluminum particles, zinc particles, sand, composite metal particles, crushed glass, crushed nut shells, and combinations thereof.

The resuspended solids in the predominantly unmixed portion of the reactor can be retained in the reactor or at least a portion of the resuspended solids can be wasted from the reactor together with ther treated liquid. The retention of the resuspended solids can be done by temporarily closing a manual mechanical valve on a discharge line for the treated water, closing a motorized mechanical valve, closing a manual pinch valve, closing a pinch valve with a drive, interrupting the flow with a float-up conduit, producing a counterflow of a treated or clean liquid with a mechanical pump, producing a counterflow of a treated or clean liquid with an airlift, and combinations thereof. Discharging at least a portion of the treated liquid during the step of periodically resuspending said solids in said unmixed portion of the reactor can also be provided. The interrupting of the flow can be done with automatic interrupting means, manual interrupting means, and combinations thereof. It is understood that this portion of the treated water may be not completely separated from the resuspended solids.

The gravity separated solid-liquid mixture in the predominantly unmixed portion of the reactor can be additionally filtered. The filtration can be done using membrane filtration, ultrafiltration, hollow fiber membrane filtration, filtration through granular media, filtration through sacrificial metal media, filtration through fibrous media, filtration through plastic media, filtration through floating media, filtration through fixed bed media, filtration through moving bed media, downflow filtration, upflow filtration, crossflow filtration, and combinations thereof. The sacrificial metal media can be made of iron, nickel, cobalt, aluminum, zinc, and other metals capable of eliminating admixtures to the liquid. The plastic media can be represented by flat plastic sheets, corrugated plastic sheets, blocks made of plastic sheets, plastic netting, tubes of plastic netting, screw-shaped plastic rods, plastic saddles, gothic structures, plastic beads, scored plastic beads, and combinations thereof. At least intermittent aeration during the filtration step can be provided. Recirculating of at least a portion of the clarified and filtered liquid during filtration can be provided. The filtration media is periodically regenerated. the regeneration can be done by liquid, air, and combinations of both. A step of interrupting discharging at least a portion of the separated and filtered liquid during the regeneration of the filtration media can be provided. The methods of interrupting are the same as those for the gravity separated liquid: closing a manual mechanical valve, closing a motorized mechanical valve, closing a manual pinch valve, closing a motorized pinch valve, actuating a float-up conduit, producing a counterflow of a treated or clean liquid using a pump, producing a counterflow of a treated or clean liquid using an airlift, and combinations thereof The interrupting can be by using automatic interrupting means, manual interrupting means, and combinations thereof

In the predominantly mixed (contact) portion of the reactor, functional zones can be provided comprising at least one strongly aerobic zone, at least one air-based aerobic zone, at least one nitrification zone, at least one zone of oxidation of ferrous iron, at least one microaerophylic zone, at least one denitrification zone, at least one zone of ferric ion reduction, at least one fermentation zone, at least one acidification zone, at least one zone of hydrolysis of particulate organic, at least one zones of reduction of sulfate, at least one zone of reduction of carbonates, at least one zone of formation of methane, at least one zone with continous aeration, at least one zone with continuous mixing, at least one zone with intermittent aeration, at least one zone with intermittent mixing, at least one quiescent biological treatment zone, at least one zone of treatment with a sacrificial metal, and combinations thereof.

The process can be performed in an apparatus comprising a reactor with at least one reaction zone and at least one solids separation zone, said zones can be without distinct borders. The reaction zone is predominantly mixed zone, while the separation zone is predominantly unmixed zone. The liquid influent is fed in the predominantly mixed zone while the treated and clarified effluent is discharged from the predominantly unmixed zone. Preferably, the treated liquid is discharged during the unmixed period in the unmixed portion of the rector. If the treated liquid is discharged during the resuspension period, an elevated concentration of suspended solids may result and the treated liquid may meed additional separation of solids.

The apparatus can be provided with a means for interrupting the discharge of the liquid and the solids. The apparatus can be further provided with means for recirculating the liquid and the solids. The means for recirculating can be pumps, airlifts, mixers, mechanical aerators, diffused air aerators, flow ejectors, and combinations thereof. The floating apparatus can be provided with support floats and with landing gear for proper positioning of the filtration and biofiltration equipment (tertiary treatment equipment) in a drained or partially drained reactor.

### DRAWINGS

FIG. 1 is a plan view of the base system for conducting the present process.

FIG. 2 is a section along line I-I in FIG. 1 across the predominantly unmixed portion of the apparatus (right side) and unmixed portion of the reactor (left side)

FIG. 3 is an enlarged section of the predominantly unmixed portion of the rector with a filter built-in and with an airlift for interrupting the flow.

FIG. 4 is a section of the filter along lines II-II in FIG. 3 during the filtration period.

FIG. 5 is a section of the filter along lines II-II in FIG. 3 during the regeneration period.

FIG. 6 is an enlarged section of the predominantly unmixed portion of the rector with a biofilter built-in and with a float-up means for interrupting the flow.

FIG. 7 is a section of the filter along lines III-III in FIG. 6 during the filtration period.

FIG. 8 is a section of the filter along lines III-III in FIG. 6 during the regeneration period.

FIG. 9 is an illustration of a floating filter or biofilter built-in a predominantly unmixed portion of the reactor in a floating position

FIG. 10 is an illustration of a floating filter or biofilter built-in a predominantly unmixed portion of the reactor in a drained-tank-position

### DETAILED DESCRIPTION OF THE INVENTION

As an example of the process, a biological wastewater treatment process is considered herein.

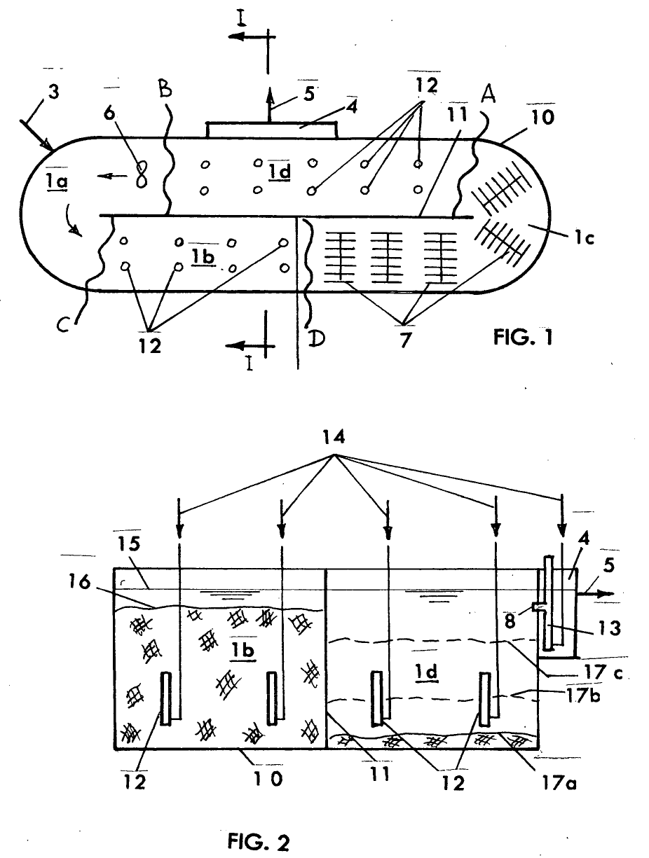

Referring now to FIGS. 1 and 2, there is shown the basic system for conducting the present invention. The system includes a tank 10 with a baffle (inside wall) 11. The tank is divided into zones 1a, 1b, and 1c defined above as predominantly mixed (or contact) zones, and 1d representing predominantly unmixed zone. The top of the water is shown by line 15. Zone 1a may be at least periodically mixed by a propeller mixer 8 which simultaneously moves and recirculates the contents of the tank as shown by arrows. Other means for mixing and propelling can be used, for example,: pumps, airlifts. Design of such means presents no problems to those skilled in art. Lines 3 and 5 are respectively the influent and the effluent lines The influent line 5 is connected to an effluent box 4. Zone 1b may be anaerobic zone with considerably dense sludge at concentration up to 20 to 30 g/L. This zone can be continuously mixed at low intensity or periodically mixed at greater intensity, for example by airlifts 12 as shown or by mechanical mixers, or any other known mixing means, or it can be mixed with the gases produced in the biological process. In the latter case, no equipment means for mixing is needed. Zone 1c can be an aerobic zone provided with diffused air aerators 7 which are also mixing means (any other mixing-aeration means can be used), this zone is mixed with the substantial intensity and has a lower biomass concentration. Zones 1a, 1b, 1c, and 1d may be defined by fuzzy borders A, B, C, and D (no physical walls) or they may be separated by walls or other partitions. Zones 1a, 1b, and 1c may have packing for attached growth. The packing can be fixed or floating. Any packing ever mentioned in any publication can be accommodated in this process. There may be multiple zones 1a, 1b, 1c arranged in various sequences, there may be parallel zones, sidestream zones, zones on the recycle lines, zones on the biomass recycle lines, zone can be of different types, zones with sludge conditioning and cultivation under any name, zones for performing any biological transformations under any name, including any of those listed previously. Zone 1d is predominantly unmixed zone for separating the sludge. Box 4 is the discharge chamber with at least one flow collection means. Box 4 communicates with the reactor 10 via orificess 8 (or weirs, or other outlets). Flow collection means can be a weir, single or multiple orifices in the side wall, pipes with a vertical branch as shown in FIG. 2 or great many other well known arrangements.

The embodiment of FIGS. 1 and 2 is operated as follows. The wastewater influent is fed in the reactor 10 via line 3. The contents of the reactor, mixed liquor suspended solids (MLSS), consisting of wastewater and biomass are circulated by means 6 so that the influent is mixed with biomass at the point of feed. MLSS passes through zones 1a, 1b, 1c (or any combination of biological treatment zones) and undergoes the biological treatment. MLSS is periodically or continuously mixed in zones 1a, 1b, and 1c as may be needed and specified in a particular application. When the MLSS reaches predominantly unmixed zone 1d, biomass (particles of activated sludge) settles under action of gravity to the bottom area of zone 1d and a layer of clarified liquid is formed on top. This settling occurs at a flow velocity as induced by the circulation means 6, whic is much greater than that in clarifiers. A portion of the clarified liquid equal to the average flow of the influent is discharged via means 13 (weir, orifices, or other) into the effluent box 4. The sludge level in zone 1d will grow from position 17a to position 17b and so on upward. In order to circulate the settled sludge in the reactor, it is periodically resuspended. In the resuspended state, the sludge level can assume position 17d or even higher up to the top of the water. It is possible to transfer some solids from the top of zone 1d in the subsequent treatment stages, alternatively, the discharge of liquid from the reactor 10 into box 4 should be interrupted. This can be done by using airlift 13 with air supply 14 to produce a temporary counter-flow of the treated liquid from the box 4 into the reactor 10 during the sludge resuspension period. Periodic sludge resuspension in zones like zone 1b can be done with submerged airlifts 12 supplied with air through linesl4, these airlifts can be operated simultaneously, or in a queue. The advantages of the system presented in FIGS. 1 and 2 are simplicity of apparatus and operation: The process can be performed in a single tank without partitions and there is no need in sequencing the influent feed. Accordingly, capital and operation costs can be reduced.

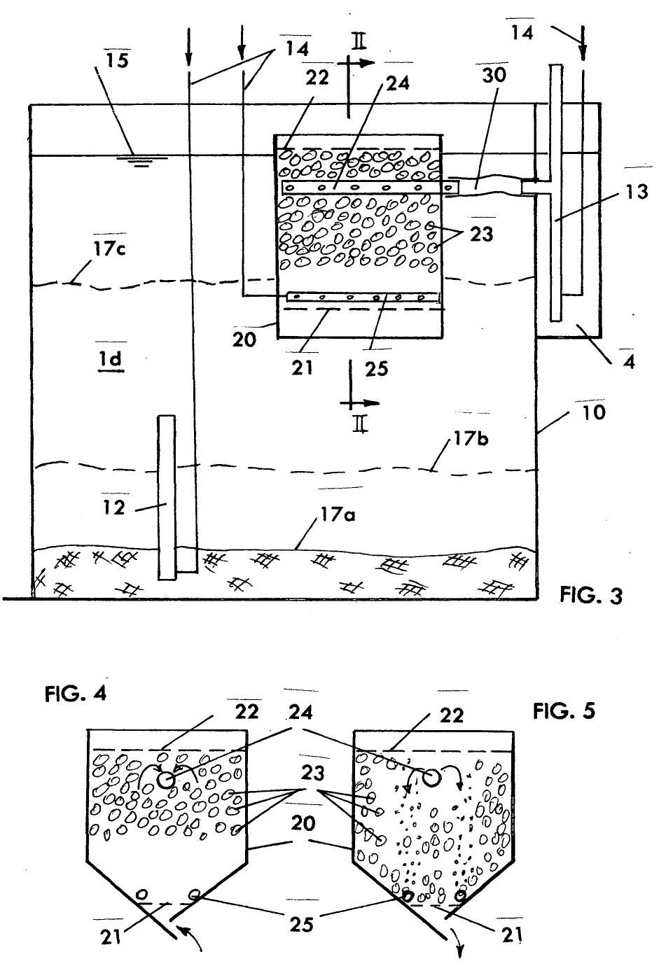

Referring now to FIGS. 3, 4, and 5, there is shown a modification of the process and apparatus with a filter built-in the sludge resuspension zone 1d. Like elements and like numbers shown in FIGS. 1 and 2 are not repeated here. The filter can be supported with a fixed support or by floats. The filter is connected by a pipe (flexible pipe for the floating filter) to the discharge orifices (or other outlets) 8. The filter comprises the body 20 with net or mesh membranes 21 at the bottom and 22 at the top. A filtration media is provided between the nets, for example, a floating media made of polyethylene and having a density close to but somewhat less than that of water. A perforated (or porous, or otherwise permeable) filtrate collection pipe 24 is provided. Pipe 24 can be positioned anywhere from the top to the bottom of the floating media in the filter. Air distribution pipes 25 are provided some distance from the bottom of the floating media. Air distribution pipes can be perforated pipes or any other known or future air diffuser. Air distributors 25 can also be made with moving elements and mixers. An open bottom can be used in the filter box 20. Alternatively, a bottom made as the Imhoff slot (shown in FIGS. 4 and 5) can also be used. The filter collection pipe 24 is connected to the outlet 8 via line 30.

The filter is operated as follows. The gravity clarified effluent enters the filter from the bottom, passes the net 21, filters through the media 23, is collected in the pipe 24, and discharged via line 30 in the box 4. While the gravity clarified water passes through the media 23, additional amount of suspended particles is removed. Biological processes on the media provide additional removal of organics. When the filter media accumulates significant amount of biomass, the break through of the solids may occur: The media should be regenerated, cleaned from the excess biomass, preferably some time before the break through occurs. The time for the backwash can be determined from the experience and set as a reliable (not too short and not too long) period between backwash. Alternatively, indication of headloss or other parameters for starting backwash may be provided. During the backwash, air is fed via lines 14 in the air distribution pipes 25 thus forming multiple bubbles in the filter media. Bubbles in water reduce the density of the contents of the filter and the filter media sinks against the flow of air bubbles. When the media reaches the unaerated layer at the bottom it turns around and goes upward in the area of less intensive aeration. Accordingly, rotation of the media occurs and the media is subjected to mechanical shaking and scouring, thus the accumulated biomass largely (but not completely) sloughs off from the filter media and drops down through the open bottom (or Imhoff bottom) of the filter into the reactor (zone 1d). During the backwash, air is fed in the airlift 13 and a counterflow of liquid is induced. A reasonably small amount of the clean liquid (a small fraction of the filtrate flow) is fed back in the pipe 24 and further in the filter body 20 and out in the reactor 10. Accordingly, the transfer of suspended solids with the stirred flow from the filter into the box 4 during its backwash is prevented. The air feed for the backwash and the flow interruption can be provided from the same line and turned on and off simultaneously by manual or automatic means (not shown).

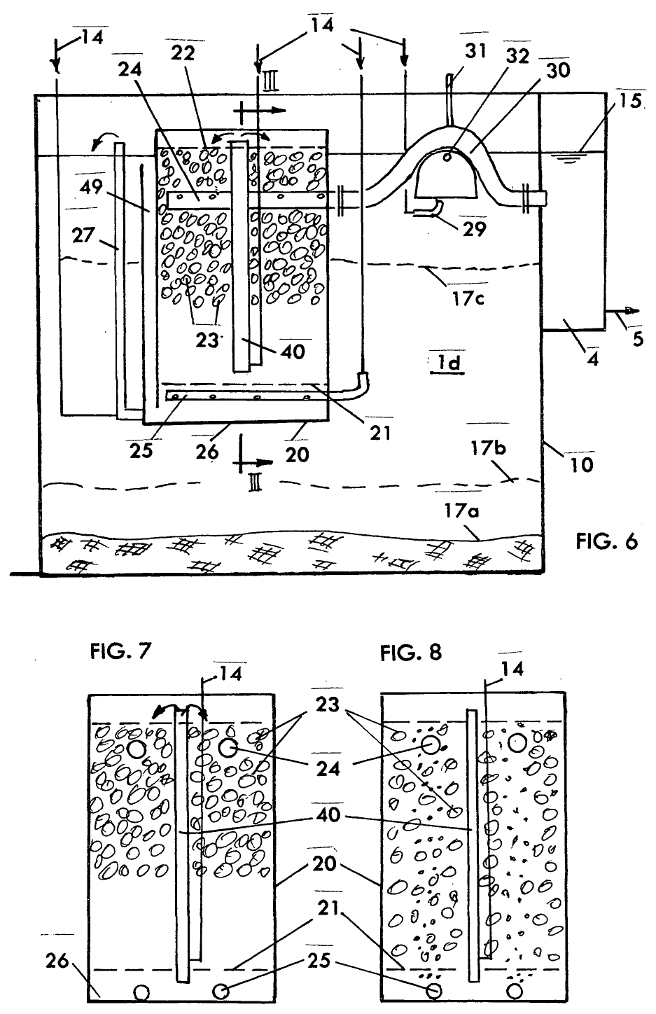

Referring now to FIGS. 6, 7, and 8, there is shown a modification of the process and apparatus with a biofilter built-in the sludge resuspension zone 1d. Like elements and like numbers shown in FIGS. 1 and 2 and FIGS. 3, 4, and 5 are not repeated here. The biofilter can be supported with a fixed support or by floats. The biofilter is connected by a conduit to the discharge orifices (or other outlets) 8. Biofilter on the fixed support can be connected by a hard pipe, a flexible pipe can be used for the floating biofilter. The biofilter comprises the body 20 with net or mesh membranes 21 at the bottom and 22 at the top. A biofiltration media is provided between the nets, for example, a floating media made of polyethylene and having a density close to but somewhat less than that of water. A perforated (or porous, or otherwise permeable) filtrate collection pipe 24 is provided. Pipe 24 can be positioned anywhere from the top to the bottom of the floating media in the biofilter. Air distribution pipes 25 are provided some distance from the bottom of the floating media. Air distribution pipes can be perforated pipes or any other known or future air diffuser. Air distributors 25 can also be made with moving elements and mixers. An open bottom can be used in the filter box 20. Alternatively, a closed bottom (shown in FIGS. 4 and 5) can also be used. The filtrate collection pipe 24 is connected to the outlet 8 via flexible line 30 with air release 31. A floating body 28 shaped as a half-barrel with open lower side is positioned under the line 30. An air feed 29 is provided under the body 28 and is connected to the air line 14. The half-barrel body has an air release orifice 32 in the upper part of the side wall (or on the very top). The intake channel 49 for the gravity clarified water is provided (shown on the left side of the body 20). This intake preferably takes liquid from the top of the zone 1d. An airlift 27 is also provided for pumping out the settled solid separated from the bed during the regeneration. An aeration-mixing airlift 40 within the filtration media is supplied with air air line 14, the airlift brings the liquid from the bottom of the body 20 to its top.

The biofilter is operated as follows. The gravity clarified effluent enters the biofilter from the top of the intake channel 40, goes to the bottom of the body 20, passes the net 21 filters through the media 23, is collected in the pipe (or pipes) 24, and is discharged via line 30 in the box 4. At the same time, the flow of the gravity clarified liquid is circulating in the biofiltration media with the use of airlift 40 (see FIG. 7), is saturated with oxygen, and undergoes additional biological treatment. While the gravity clarified water passes through the media 23, additional amount of suspended particles is removed. Biological processes on the media provide substantial removal of organics. Carbon dioxide is stripped and calcium carbonate and iron hydroxide (and some other metals including many heavy metals) are precipitated into biomass. When the biofilter media accumulates significant amount of biomass, the break through of the solids may occur. The media should be regenerated, cleaned from the excess biomass, preferably some time before the break through occurs. The time for the backwash can be determined from the experience and set as a reliable (not too short and not too long) period between backwash. Alternatively, indication of headloss or other parameters may be provided. During the backwash, air is fed via lines 14 in the air distribution pipes 25 thus forming multiple bubbles in the filter media. The airlift 40 need not be operated (FIG. 8). Bubbles in water reduce the density of the contents of the filter and the filter media sinks against the flow of air bubbles. When the media reaches the nonaerated layer at the bottom it turns around and goes upward in the area of less intensive aeration. Accordingly, rotation of the media occurs and the media is subjected to mechanical shaking and scouring, thus the accumulated biomass partially sloughs off from the filter media and drops down to the bottom of the biofilter. The scoured solids are removed from the biofilter by airlift 27 into the reactor 10. During the backwash, air is also fed in the drum 28 via means 29 and line 14, a portion of this air is lost through the orifice 32, however, air displaces the liquid in the half-drum space thus lifting the line 30 above the liquid level 15 in the reactor 10. Line 31 interrupts the syphon flow and the flow from the biofilter to the box 4 is also interrupted. Accordingly, the transfer of suspended solids with the stirred flow from the biofilter into the box 4 during its backwash is prevented. When the air supply to pipes 25 and the half-drum 28 are discontinued at the end of the backwash, the half-drum releases the air through the orifice 32 and sinks thus bringing the line 30 down and opening the liquid flow from the biofilter 20 to the box 4 again. At this time, the air supply to the circulation and oxygen saturation airlifts 40 also resumes. Accordingly, the biofiltration cycle is repeated. Optionally, the liquid recycle can be done by mechanical means (a pump) without aeration. This would provide an opportunity to use aerobic-anaerobic cycling in the biofilter. Additionally, the biofilter can be made of several sections with aerobic, anoxic, anaerobic conditions, the cycling of ferric and ferrous ions can be used (ferrous ions can reduce nitrates and nitrites and become ferric ions, while the ferric ions can oxidize ammonia). Additionally, many organics can be oxidized and reduced in the ferric-ferrous cycle. Biofiltration of the biologically treated and gravity clarified wastewater provides removal of constituents that cannot be removed efficiently in usual biological steps.

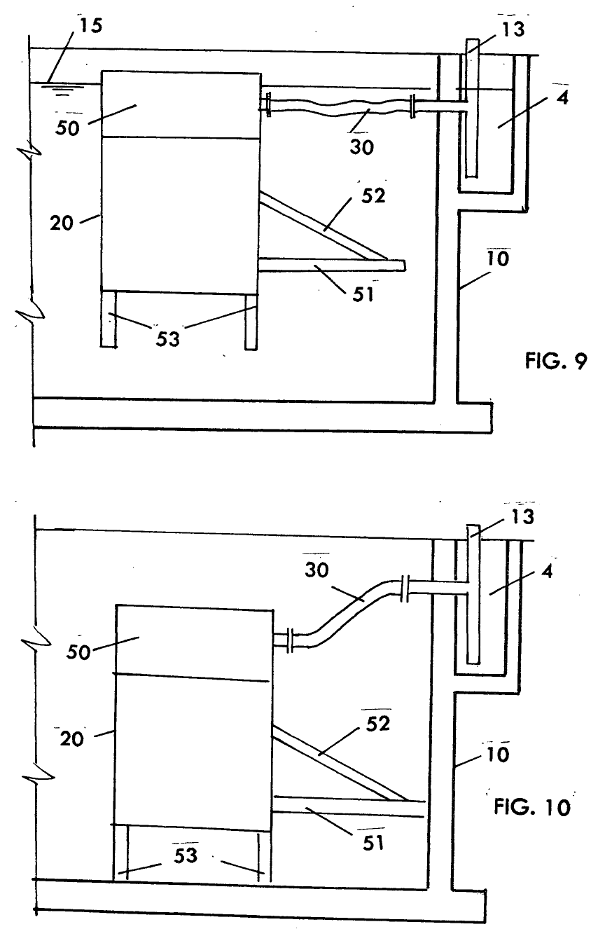

Referring now to FIGS. 9 and 10, there is shown the floating filter (or biofilter) 20 with floats 50 attached to the body 20. The filter is connected by the flexible line 30 via optional airlift 13 to the discharge box 4. The box 20 is provided with legs 53 or, alternatively, with a brace or support, for example, made of bars 51 and 52. Other designs of legs or braces can be also used by the skilled in art. When the liquid level in the tank 10 is at the elevation marked by 15, the legs 53 are off the floor of the reactor 10. When the reactor is partially, or completely emptied, the box 20 descends and the legs 53 reach the floor of the reactor 10. Alternatively, if the body 20 is provided with bars 51 and 52, in the descended position, the box 20 is supported by the combination of the flexible conduit 30 and bars 51 and 52 supporting the whole structure on the vertical wall. Hinged braces can evidently be used instead of flexible liks in form of flexible conduit 30. Obviously, only legs 53 or the bars 51 and 52 need to be used. It should be understood that the filtration (or biofiltration) units 20 can be built-in the existing conventional clarifiers. In case of the floating units, they will be positioned above the sludge scapers in clarifiers and land on the bottom or on the wall when clarifiers are emptied. Filters and biofilters built-in the described system can be called tertiary treatment equipment.

It will therefore be understood by those skilled in the art that particular embodiments of the invention here presented are by way of illustration only, and are meant to be in no way restrictive; therefore, numerous changes and modifications may be made, and the full use of equivalents resorted to, without departing from the spirit and the scope of the invention as outlined in the appended claims.

What is claimed is:

1. A method of batch-continuous operation for treatment and separation of liquid-solid mixtures in a reactor with reactive solids comprising steps of continuously feeding the said liquid in said reactor, contacting said liquid with said solids in at least a portion of said reactor, periodically separating said liquid from said solids in unmixed portion of said reactor, discharging at least a portion of said separated liquid from the reactor, and retaining said separated solids in said unmixed portion of said reactor, and periodically resuspending said solids in said unmixed portion of the reactor and transferring said resuspended soilds in said portion of said reactor for mixing said liquid with said solids.

2. The method as claimed in claim 1, wherein said mixing said liquid with said solids is selected from the group comprising continuous mixing, and periodic mixing.

3. The method as claimed in claim 1, wherein said liquid is selected from the group comprising water, process water, wastewater, water solutions, biological growth media, water with dissolved organics, water with particulate organics, organic liquid, petroleum, petroleum products, and combinations thereof.

4. The method as claimed in claim 1, wherein said reactive solids are selected from the group comprising biomass, activated sludge, flocculent sludge, granular sludge, attached biological growth to the fixed media, attached biological growth to moving media, organic particles, inorganic particles, mineral particles, activated carbon, ion exchange resins, metal particles, iron particles, aluminum particles, zinc particles, sand, crushed glass, crushed nut shells, and combinations thereof

5. The method as claimed in claim 1 and further subjecting said resuspended solids in said unmixed portion of the reactor to a step selected from the group of retaining said resuspended solids in said reactor, wasting at least a portion of said resuspended solids from said reactor.

6. The method as claimed in claim 5, wherein said step of retaining said resuspended solids is selected from the group comprising closing a manual mechanical valve, closing a motorized mechanical valve, closing a manual pinch valve, closing a pinch valve with a drive, interrupting the flow with a float-up conduit, producing a counterflow of a treated or clean liquid with a mechanical pump, producing a counterflow of a treated or clean liquid with an airlift, and combinations thereof.

7. The method as claimed in claim 1 and further providing a step of interrupting discharging at least a portion of said separated liquid during said of periodically resuspending said solids in said unmixed portion of the reactor.

8. The method as claimed in claim 7 wherein said interrupting is selected from the group of automatic interrupting means, manual interrupting means, and combinations thereof.

9. The method as claimed in claim 1 and further providing a step of filtration of said separated liquid.

10. The method as claimed in claim 9, wherein said step of filtration is selected from the group comprising membrane filtration, ultrafiltration, filtration through granular media, filtration through sacrificial metal media, filtration through fibrous media, filtration through plastic media, filtration through floating media, filtration through fixed media, filtration through moving media, downflow filtration, upflow filtration, crossflow filtration, and combinations thereof

11. The method as claimed in claim 10, wherein said plastic media is selected from the group comprising flat plastic sheets, corrugated plastic sheets, blocks made of palstic sheets, plastic netting, tubes of plastic netting, screw-shaped plastic rods, plastic saddles, gotic structures, and combinatios thereof.

12. The method as claimed in claim 9 and further providing at least intermittent aeration during said step of filtration.

13. The method as claimed in claim 9 and further providing recirculation of at least a portion of said clarified liquid during said step of filtration.

14. The method as claimed in claim 9 as further providing a step of interrupting discharging at least a portion of said separated liquid during said step of filtration.

15. The method as claimed in claim 14, wherein said interrupting is selected from the group comprising closing a manual mechanical valve, closing a motorized mechanical valve, closing a manual pinch valve, closing a motorized pinch valve, actuating a float-up conduit, producing a counterflow of a treated or clean liquid using a pump, producing a counterflow of a treated or clean liquid using an airlift, and combinations thereof.

16. The method as claimed in claim 14 wherein said interrupting is selected from the group of automatic interrupting means, manual interrupting means, and combinations thereof.

17. The method as claimed in claim 4 and further providing treatment zones selected from the group comprising at least one strongly aerobic zone, at least one air-based aerobic zone, at least one nitrification zone, at least one zone of oxidation of ferrous iron, at least one microaerophylic zone, at least one denitrification zone, at least one zone of ferric ion reduction, at least one fermentation zone, at least one acidification zone, at least one zone of hydrolysis of particulate organic, at least one zones of reduction of sulfate, at least one zone of reduction of carbonates, at least one zone of formation of methane, at least one zone with continous aeration, at least one zone with continous mixing, at least one zone with intermittent aeration, at least one zone with intermittent mixing, at least one quiescent biological treatment zone, and combinations thereof.

18. An flow-through apparatus for conducting the method as described in claim 1 comprising a reactor with at least one reaction zone and at least one solids separation zone, said zones are without distinct borders.

19. The apparatus as Claimed in claim 18, wherein said solids separation zone is provided with means for interrupting the discharge of said liquid and said solids.

20. The apparatus as Claimed in claim 18 wherein means for recycling said liquid and said solids is provided.

21. The apparatus as claimed in claim 20 wherein said means for recycling are selected from the group comprising pumps, airlifts, mixers, mechanical aerators, diffused air aerators, flow ejectors, and combinations thereof.

22. The apparatus as claimed in claim 18 and further providing tertiary treatment equipment built-in said apparatus.

23. The apparatus as claimed in claim 22, wherein said equipment is selected from the group comprising fixed equipment, floating equipment, and combinations thereof.

24. The apparatus as claimed in claim 23 wherein said floating equipment is provided with landing gear.

25. The apparatus as claimed in claim 24 wherein said landing gear is selected from the group comprising bottom landing gear, wall landing gear, landing gear with bottom legs, landing gear with hinged arms, landing gear with flexible links, landing gear with horizontal supports, and combinations thereof.
